(19) United States
(12) Patent Application Publication
(10) Pub. No.: US 2009/0300844 A1
(43) Pub. Date: Dec. 10, 2009

(54) SURGICAL TABLE

(76) Inventor: Brian Taylor, New South Wales (AU)

Correspondence Address: RISSMAN HENDRICKS & OLIVERIO, LLP, 100 Cambridge Street, Suite 2101, BOSTON, MA, 02114, US

(21) Appl. No.: 12/280,719

(22) PCT Filed: Feb. 27, 2007
(86) PCT No.: PCT/AU2007/000214

§ 371 Date: Jul. 24, 2009

(30) Foreign Application Priority Data
Feb. 27, 2006 (AU) 2006900975

(51) Int. Cl. A61G 13/04; A61G 13/06

(52) U.S. Cl. 5/607

(57) ABSTRACT

A surgical table including: an upper platform for supporting a patient, the platform having a longitudinal axis extending from a first end of the platform to a second end of the platform; a base support; and, an elevator mechanism including scissor linkage members extending between and connecting the upper platform with the base support for moving the upper platform between a fully collapsed and a fully raised operating position relative to the base support. Each scissor linkage member is independently operable to raise or lower the upper platform either to move the upper platform such that it is parallel to the base support, or to lower or raise the first end of the platform independently of the second end of the platform and vice versa, causing the upper platform to tilt along its longitudinal axis.

### FIELD OF THE INVENTION

The present invention relates generally to an improved surgical table and more particularly to surgical tables for use in veterinary medicine.

### BACKGROUND TO THE INVENTION

Veterinary surgical tables are used to support animal patients during examination or surgery by a veterinary surgeon. It is desirable to elevate the animal being treated to enable the veterinarian to work in an upright position rather than kneeling or crouching to treat the animal on the floor.

Most veterinary surgical tables are of simple construction to form a fixed examination table. Whilst such tables are useful in elevating the animal to a comfortable examination and/or operating position for the attending veterinarian, it can be difficult to lift larger animals to the necessary height to place them on the table. This problem may be magnified when the animal is under sedation or anesthetization, since these conditions cause the animal to collapse making it more difficult to manoeuvre its weight. This problem is of particular relevance when treating large dogs.

### SUMMARY OF THE INVENTION

According to an aspect of the present invention, there is provided a surgical table, including:

(a) an upper platform for supporting a patient, the platform having a longitudinal axis extending from a first end of the platform to a second end of the platform;
(b) a base support;
(c) an elevator mechanism including scissor linkage members extending between and connecting the upper platform with the base support for moving the upper platform between a fully collapsed and a fully raised operating position relative to the base support;

wherein each scissor linkage member is independently operable to raise or lower the upper platform either to move the upper platform such that it is parallel to the base support, or to lower or raise the first end of the platform independently of the second end of the platform and vice versa, causing the upper platform to tilt along its longitudinal axis.

Preferably, the elevator mechanism includes two pairs of scissor linkage members and each pair of scissor linkage members is independently operable.

More preferably, each scissor linkage member includes a first member and a second member, the first member being pivotally connected to the upper platform at a first end and pivotally connected to a first end of the second member, the second end of the second member being pivotally connected to the base support.

In one embodiment of the invention, the surgical table further includes a first drive means for moving a first pair of scissor linkage members between a collapsed position and a raised operating position and a second drive means for moving a second pair of scissor linkage members between a collapsed position and a raised operating position.

The drive means may be mechanical but is preferably an electric motor. More preferably, the first and second drive means include a reversible rotary motor. Even more preferably, the first and second drive means include a planetary reduction gear box.

In one form of the invention, the first drive means is located in a first tubular member which pivotally connects the second end of the first member to the first end of the second member of the first pair of scissor linkage members and the second drive means is located in a second tubular member which pivotally connects the second end of the first member to the first end of the second member of the second pair of scissor linkage members.

In a particular form of the invention, the first and second drive means each include two individual rotary motors, each motor positioned at a hinge joint located where the second end of the first member pivotally connects to the first end of the second member of each scissor linkage member.

Preferably, the two individual rotary motors which each operate one scissor linkage member forming a pair of scissor linkage members are synchronised.

According to an embodiment, the upper platform for supporting a patient includes a plurality of panels which fold to form a hollow in the surface of the upper platform to support the patient.

Preferably, folding of the plurality of panels to form a hollow in the surface of the upper platform is actuated by a rotary motor.

### BRIEF DESCRIPTION OF THE DRAWINGS

The present invention will now be described in greater detail with reference to the accompanying drawings. It is to be understood that the particularity of the accompanying drawings does not supersede the generality of the preceding description of the invention.

FIG. 1 is a side perspective view of a surgical table in the collapsed position according to an embodiment of the present invention.

FIG. 2 is a side perspective view of the surgical table of FIG. 1 in the fully elevated position.

FIG. 3 is a side perspective view of the surgical table of FIG. 2 with the upper platform tilted in one direction.

FIG. 4 is a side perspective view of the surgical table of FIG. 2 with the upper platform tilted in the opposite direction.

FIG. 5 is a side perspective view of alternative embodiment of the present invention showing the upper platform tilted as in FIG. 4.

FIG. 6 is a top view of the upper platform.

FIG. 7 is a top view of the upper platform showing the upper platform in a folded condition.

FIG. 8 shows a supporting structure which fits between the elevator mechanism and the upper platform.

FIG. 9 shows the supporting structure of FIG. 8 mounted on the elevator mechanism and base support.

FIG. 10 is an underneath perspective view of the upper platform.

### DETAILED DESCRIPTION

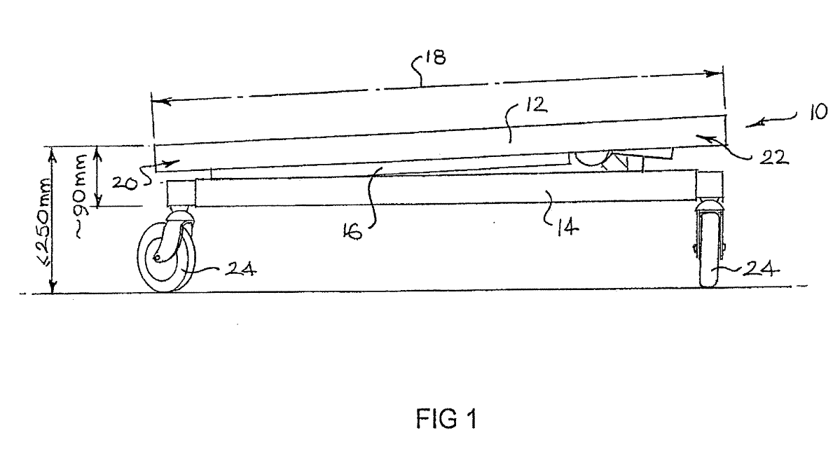

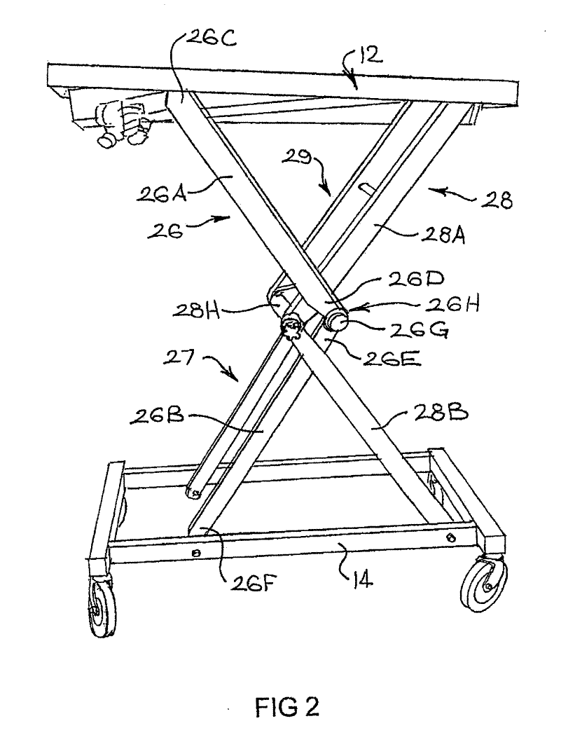

Referring firstly to FIG. 1, the present invention provides a surgical table 10, including an upper platform 12 for supporting a patient, and a base support 14 connected by an elevator mechanism 16 for moving the upper platform 12 between a fully lowered and a fully raised position. The elevator mechanism 16 includes independently operable scissor linkage members (see FIG. 2). Collapse or expansion of the scissor linkage members is controlled by an operator to lower or raise the upper platform 12 such that it is parallel to the base support 14, or to lower or raise either end of the platform 12 independently causing the upper platform 12 to tilt about its longitudinal axis 18.

In FIG. 1, the surgical table 10 is shown in the fully lowered position with the upper platform 12 lowered almost to floor level. The lowered position is useful for manoeuvring sedated or anesthetized animals onto the upper platform 12 or table top before elevating the upper platform 12 to the fully raised position shown in FIG. 2. The scissor linkage members are sufficiently compact to allow the upper platform 12 to be lowered such that it rests substantially on the base support 14. Use of the scissor linkage mechanism enables the table 10 to be collapsed to a height of less than 90 millimetres.

The upper platform 12 is generally rectangular in shape and has a substantially planar surface. The platform 12 has two ends 20, 22 and two longer sides with a longitudinal axis 18 extending between the first end 20 and the second end 22. The base support 14 consists of a steel chassis. The base support 14 is designed to enable the scissor linkage members to fit inside the framework of the chassis in the collapsed position making the surgical table 10 as compact as possible in the lowered position and bringing the upper platform 12 as close to floor level as possible without comprising the ground clearance of the chassis 14. In the illustrated embodiment, the base support 14 is mounted on casters 24 to make the surgical table 10 mobile and easily manoeuvrable. Preferably, the casters 24 are locking casters to prevent movement of the surgical table 10 during surgery.

Referring now to FIG. 2, the surgical table 10 is shown in the fully raised position with the elevator mechanism 16 expanded to its maximum capacity. The elevator mechanism 16 includes two pairs of scissor linkage members 26, 28. Each pair of scissor linkage members is linked so that whilst the operation of each pair of scissor linkage members 26, 28 is independent, the operation of the two scissor linkage members, i.e. 26A, 26B and 28A, 28B making up each pair 26, 28 is synchronised.

Each scissor linkage member includes a first member 26A and a second member 26B. The first member 26A is pivotally connected to the upper platform 12 at a first end 26C and pivotally connected to a first end 26E of the second member 26B. The second end 26D of the first member 26A and the first end 26E of the second member 26B are pivotally connected via a hinge joint 26G and are linked to the hinge joint of the other scissor linkage member making up the pair of scissor linkage members via a cross linkage tube 26H (see also 28H). The second end 26F of each second scissor linkage member 26B is pivotally connected to the base support 14.

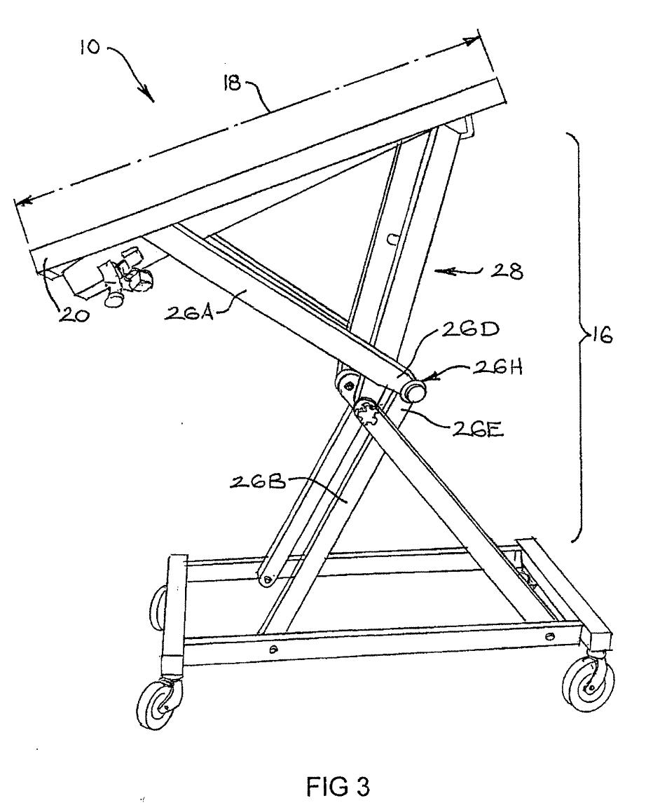

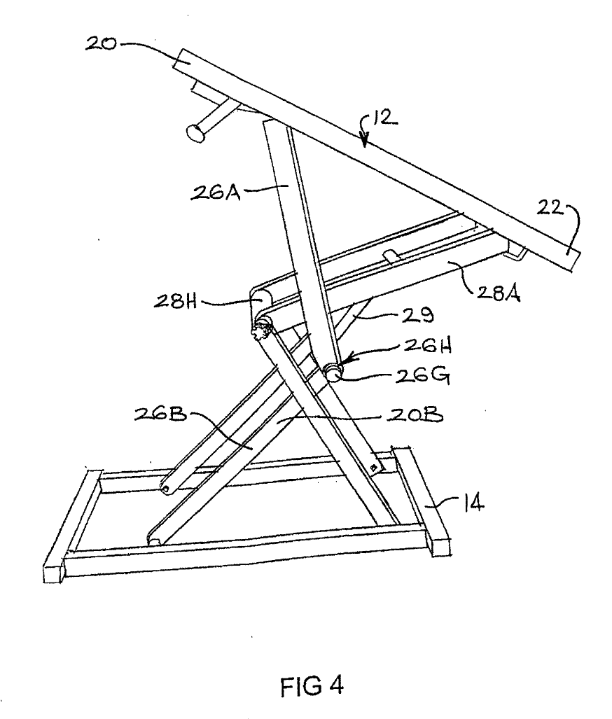

Referring now to FIGS. 3 and 4, the surgical table 10 is shown with the upper platform 12 tilted along its longitudinal axis 18. The degree of tilt of the platform 12 is achieved by and controlled by the independent expansion of the first or second pair of scissor linkage members 26, 28. As seen in FIG. 2, extending both pairs of scissor linkage members 26, 28 to the same extent raises the upper platform 12 in to horizontal position. However, by expanding the pair of scissor linkage members 28 which lift the second end 22 of the platform 12 to a greater extent than the pair of scissor linkage members 26 which lift the first end 20 of the platform 12, the platform 12 is caused to tilt.

The ability to tilt the platform 12 allows the surgeon to place the patient in the Trendelenburg position or the Reverse Trendelenburg position. The Trendelenburg position involves positioning the patient such that the patient's spine is elevated above the patient's head. In the Reverse Trendelenburg position, the patient's head is elevated above the patient's spine. These positions use the influence of gravity on viscera to facilitate clearer imaging and/or surgical exposure.

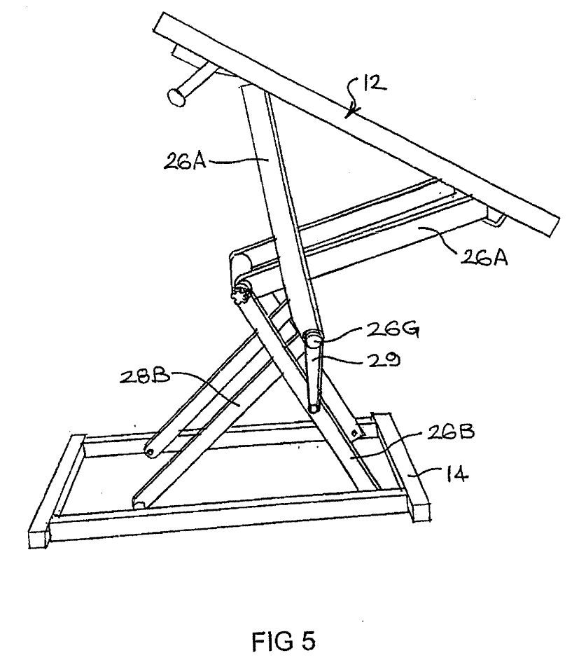

The two pairs of scissor linkage members 26, 28 are interconnected and coordinated by a stabilizing cross link member 29. The stabilizing cross link member 29 consists of a fixed length link connecting a hinge 26G (or the cross linkage tube 26H) associated with one pair of scissor linkage members (say 26) to an arm of another pair of scissor linkage members (say 28A as shown in FIG. 4 or 28B as shown in FIG. 5). Two alternative embodiments showing the position of the stabilizing cross link are shown in FIGS. 4 and 5.

The elevator mechanism 16 may be operable using mechanical or hydraulic means or may utilise electrical drive means for moving each pair of scissor linkage members 26, 28 between the collapsed position and the expanded condition. In one particular embodiment of the invention, independent drive means for each pair of scissor linkage members 26, 28 each include a rotary motor. The rotary motor is located in the cross linkage tube 26H, 28H of each pair of scissor linkage members 26, 28.

The rotary motor may be associated with a planetary gear system to provide the amount of torque required to elevate the upper platform 12 when supporting the weight of a large animal and also to enable the output direction to be reversed. The planetary gear system may be of the type having a sun gear driven by the drive motor, a ring gear and a plurality of planet gears associated with a planet carrier. The sun gear engages the planet gears, which in turn engage the inside of the ring gear. The gear ratio that may be generated by the planetary gear system relates to the number of teeth on the inside of the ring gear and number of teeth on the sun gear. An example of a suitable gear ratio is in the range of up to 1:10,000. The final choice of gear ratio will depend on motor selection. An output shaft of the planetary gear system drives a cam as the input of a planocentric reduction mechanism.

First and second drive means for moving the first and second pairs of scissor linkage members may each include two individual rotary motors. In this case, each motor is positioned at a hinge joint located where the second end 26D of the first member 26A pivotally connects to the first end 26E of the second member 26B of each scissor linkage member. The two individual rotary motors each operating a scissor linkage member forming a pair of scissor linkage members should be synchronised.

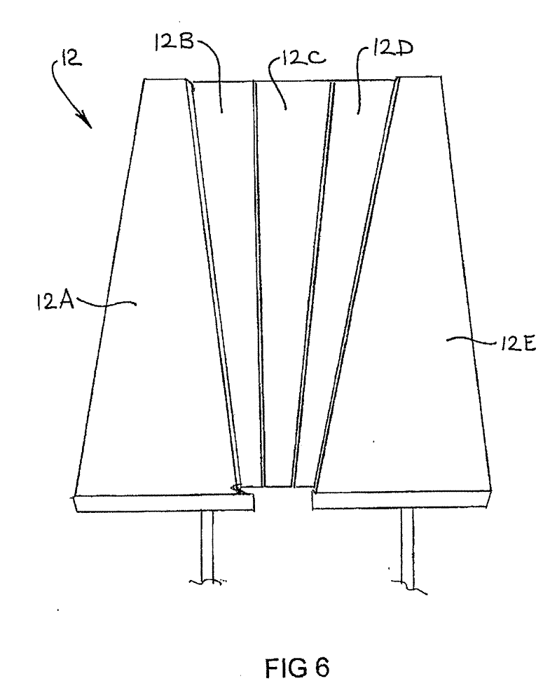

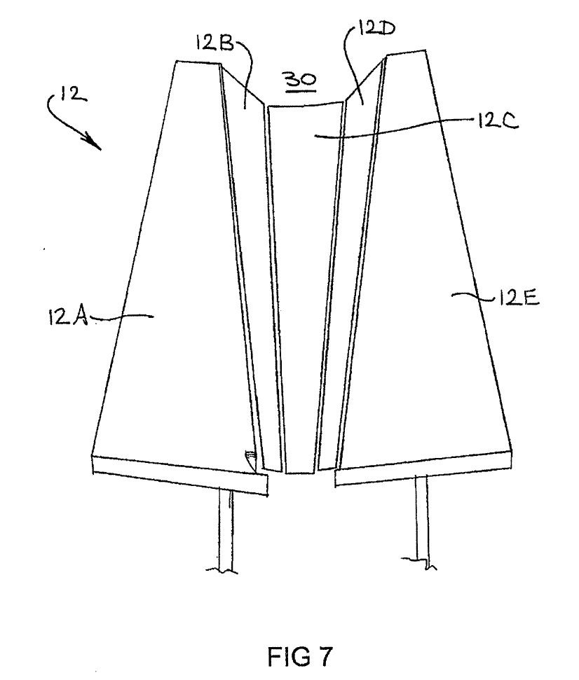

Referring now to FIGS. 6 and 7, according to an embodiment, the upper platform 12 may include a plurality of panels 12A to 12E which fold to form a hollow 30 in the surface of the upper platform 12 to support the patient. The hollow 30 is useful for supporting animals in the dorsal recumbency position, i.e. where the animal is laid on its back. Since the shape of the back of animals such as cats and dogs approximates a triangle, the recumbent position can be difficult to maintain on a planar surface. The plurality of panels is folded into a supportive hollow 30 forming an approximate U or V-shape as shown in FIG. 6. When the platform 12 folds into a hollow, the outer leaves 12A and 12E of the platform 12 tend to lift up slightly along the outer edges. This feature facilitates directed drainage of bodily fluids. Panel 12C may be replaced by a V-shaped panel and grate to better provide drainage. Panels 12B and 12D may contain “air bags” to facilitate rotation of the patient about its longitudinal axis.

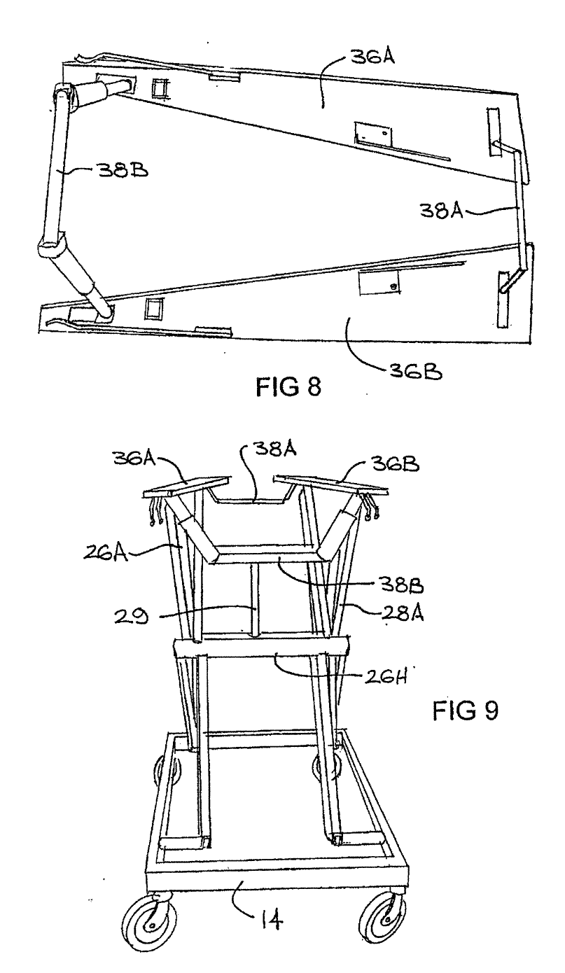

Referring now to FIG. 8, supporting panels 36A, 36B provide support for the outer leaves 12A, 12E of the platform 12. The supporting panels 36A, 36B are connected via structural members 38A, 38B. Aside from providing structural support, structural members 38A, 38B may also provide a useful handle for manoeuvring the surgical table 10. In one embodiment structural member 38B is fitted with a rubber grip to facilitate its function as a handle. Structural member 38B may be attached to supporting panels 36A and 36B by a friction regulated mechanism to allow positioning of a drainage collection vessel. The supporting panels 36A, 36B are mounted via clevis' 37 on the ends 26C, 28C of scissor linkage members 26A, 28A. The plurality of panels 12A to 12E are mounted via spring mounted bal joints to the supporting panels 36A, 36B. Referring now to FIG. 9, there is shown the supporting panel structure mounted on the elevator mechanism.

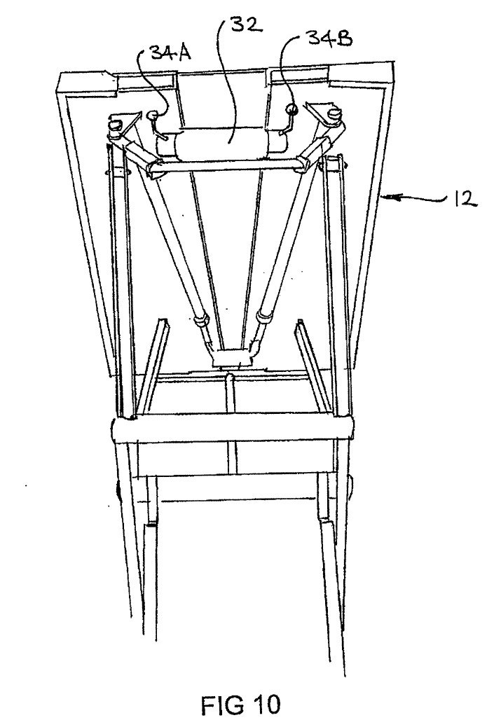

Referring now to FIG. 10, the folding of the plurality of panels 12A to 12E to form a hollow 30 in the surface of the upper platform 12 is actuated by a rotary motor 32. The motor shaft is fitted with a crank at each end 34A, 34B, each crank bent at approximately right angles to apply a force to the folding panels 12B, 12D causing them to maintain the planar condition of the upper platform 12. By reversing the motor 32, the force applied to the panels 12B, 12D is removed causing the panels to recede to the folded condition.

The surgical table of the present invention may include various further accessories such as an intravenous drip stand, drip trays and instrument trays as required.

It is to be understood that the surgical table described herein is adapted to be used for human or animal patients. The table will preferably be composed of a durable, non corrosive and easy to clean material such as stainless steel.

It is to be understood that various additions, alterations and/or modifications may be made to the parts previously described without departing from the ambit of the invention.

1. A surgical table, including:
(a) an upper platform for supporting a patient, the platform having a longitudinal axis extending from a first end of the platform to a second end of the platform;
(b) a base support;
(c) an elevator mechanism including scissor linkage members extending between and connecting the upper platform with the base support for moving the upper platform between a fully collapsed and a fully raised operating position relative to the base support;
wherein each scissor linkage member is independently operable to raise or lower the upper platform either to move the upper platform such that it is parallel to the base support, or to lower or raise the first end of the platform independently of the second end of the platform and vice versa, causing the upper platform to tilt along its longitudinal axis.

2. A surgical table according to claim 1, wherein the elevator mechanism includes two pairs of scissor linkage members and each pair of scissor linkage members is independently operable.

3. A surgical table according to claim 2, wherein each scissor linkage member includes a first member and a second member, the first member being pivotally connected to the upper platform at a first end and pivotally connected to a first end of the second member, the second end of the second member being pivotally connected to the base support.

4. A surgical table according to claim 2, further including a first drive means for moving a first pair of scissor linkage members between a collapsed position and a raised operating position and a second drive means for moving a second pair of scissor linkage members between a collapsed position and a raised operating position.

5. A surgical table according to claim 4, wherein the first and second drive means include a reversible rotary motor.

6. A surgical table according to claim 4, wherein the first and second drive means include a planetary reduction gear box.

7. A surgical table according to claim 4, wherein the first drive means is located in a first tubular member which pivotally connects the second end of the first member to the first end of the second member of the first pair of scissor linkage members and the second drive means is located in a second tubular member which pivotally connects the second end of the first member to the first end of the second member of the second pair of scissor linkage members.

8. A surgical table according to claim 4, wherein the first and second drive means each include two individual rotary motors, each motor positioned at a hinge joint located where the second end of the first member pivotally connects to the first end of the second member of each scissor linkage member.

9. A surgical table according to claim 8, wherein two individual rotary motors which each operate one scissor linkage member forming a pair of scissor linkage members are synchronised.

10. A surgical table according to claim 1, wherein the upper platform for supporting a patient includes a plurality of panels which fold to form a hollow in the surface of the upper platform to support the patient.

11. A surgical table according to claim 9, wherein folding of the plurality of panels to form a hollow in the surface of the upper platform is actuated by a rotary motor.

12. A surgical table according to claim 3, further including a first drive means for moving a first pair of scissor linkage members between a collapsed position and a raised operating position and a second drive means for moving a second pair of scissor linkage members between a collapsed position and a raised operating position.

13. A surgical table according to claim 5, wherein the first and second drive means include a planetary reduction gear box.

14. A surgical table according to claim 5, wherein the first drive means is located in a first tubular member which pivotally connects the second end of the first member to the first end of the second member of the first pair of scissor linkage members and the second drive means is located in a second tubular member which pivotally connects the second end of the first member to the first end of the second member of the second pair of scissor linkage members.

15. A surgical table according to claim 6, wherein the first drive means is located in a first tubular member which pivotally connects the second end of the first member to the first end of the second member of the first pair of scissor linkage members and the second drive means is located in a second tubular member which pivotally connects the second end of the first member to the first end of the second member of the second pair of scissor linkage members.

16. A surgical table according to claims 5, wherein the first and second drive means each include two individual rotary motors, each motor positioned at a hinge joint located where the second end of the first member pivotally connects to the first end of the second member of each scissor linkage member.

17. A surgical table according to claims 6, wherein the first and second drive means each include two individual rotary motors, each motor positioned at a hinge joint located where the second end of the first member pivotally connects to the first end of the second member of each scissor linkage member.

18. A surgical table according to claims 7, wherein the first and second drive means each include two individual rotary motors, each motor positioned at a hinge joint located where the second end of the first member pivotally connects to the first end of the second member of each scissor linkage member.

19. A surgical table according to claim 2, wherein the upper platform for supporting a patient includes a plurality of panels which fold to form a hollow in the surface of the upper platform to support the patient.

20. A surgical table according to claim 3, wherein the upper platform for supporting a patient includes a plurality of panels which fold to form a hollow in the surface of the upper platform to support the patient.
